(19) United States
(12) Patent Application Publication
(10) Pub. No.: US 2019/0091081 A1
(43) Pub. Date: Mar. 28, 2019

(54) Sacroiliac Treatment Apparatus and Method

(71) Applicants: Mary M. Sorg, Waterford, PA (US); Karen Kidder, Waterford, PA (US); Daniel J. Olson, Erie, PA (US)

(72) Inventors: Mary M. Sorg, Waterford, PA (US); Karen Kidder, Waterford, PA (US); Daniel J. Olson, Erie, PA (US)

(21) Appl. No.: 16/081,142

(22) PCT Filed: Mar. 3, 2017
(86) PCT No.: PCT/US17/20826

§ 371 Date: Aug. 30, 2018

Related U.S. Application Data
(60) Provisional application No. 62/303,610, filed on Mar. 4, 2016.

(51) Int. Cl. A61G 5/12; A61G 5/10

(52) U.S. Cl. CPC A61G 5/124; B62J 1/007; A61G 5/1091

(57) ABSTRACT

A sacroiliac (SI) treatment apparatus and method includes a seat corrector that improves alertness for a user and helps to treat and alleviate SI joint pain, restless legs, poor posture, bladder control problems, leg cramps, ischial tuberosity pain, gluteal bursitis, neck pain, knee pain, hip pain, headaches/migraines, sciatica, peripheral neuropathy, radiculitis, Parkinsons disease, and other conditions benefiting from improved posture and seated pressure on the ischial tuberosities.

### BACKGROUND

When the human body is in a seated position, many chairs or other seating apparatuses fail to promote proper positioning of the pelvis. Rather, such apparatuses may bias the body toward a position in which the pelvic region is rolled forward so that the spine, sacroiliac joints, knees, and other aspects of the skeletal system are stressed and less able to properly support the body.

### SUMMARY

A sacroiliac (SI) treatment apparatus and method includes a seat corrector that improves alertness for a user and helps to treat and alleviate SI joint pain, restless legs, poor posture, bladder control problems, leg cramps, ischial tuberosity pain, gluteal bursitis, neck pain, knee pain, hip pain, headaches/migraines, sciatica, peripheral neuropathy, radiculitis, Parkinsons disease, and other conditions benefiting from improved posture and seated pressure on the ischial tuberosities.

The sacroiliac treatment apparatus comprises a seat corrector including a base having a base sufficiently firm to resist the apparatus assuming a conforming shape to an environmental surface upon which seat corrector is placed. An upraised portion is positioned along the top surface of the base, the upper surface of the upraised portion being higher than the top surface of the base when the bottom surface of the seat corrector contacts the environmental surface.

The upraised portion of the seat corrector is positioned to exert pressure against both ischial tuberosities of the user and support the majority of the user's seated weight when the user is seated on the apparatus. The upper surface of the upraised portion extends at least the entire width between the user's ischial tuberosities when the user is seated on the apparatus.

### BRIEF DESCRIPTION OF THE DRAWINGS

For a more complete understanding and appreciation of this invention, and its many advantages, reference will be made to the following Detailed Description taken in conjunction with the accompanying drawings.

FIG. 1A is a perspective view of a seat corrector according to one embodiment of the invention;

FIG. 1B is a side view of the seat corrector of FIG. 1A;

FIG. 2 is a side view of a seat corrector according to one embodiment of the invention;

FIG. 3 is a front view depicting the positioning of the seat corrector of FIGS. 1A and 1B with respect to a user's pelvic region;

FIG. 4 is a side view depicting the positioning of the seat corrector of FIGS. 1A and 1B with respect to a user's pelvic region;

FIG. 5A is a top view of a seat corrector according to one embodiment of the invention;

FIG. 5B is a bottom view of a seat corrector according to one embodiment of the invention;

FIG. 6A is a perspective view of a seat corrector according to one embodiment of the invention;

FIG. 6B is a side view of a seat corrector according to one embodiment of the invention;

FIG. 7 is a perspective view of a seat corrector according to one embodiment of the invention;

FIG. 8 is a perspective view of a seat corrector according to one embodiment of the invention;

FIG. 9 is a top cross sectional view of a seat corrector according to one embodiment of the invention;

FIG. 10 is a side view of a seat corrector on the body of a wearer according to one embodiment of the invention;

FIG. 11A is a perspective view of a base of a seat corrector according to one embodiment of the invention;

FIG. 11B is a bottom view of an upraised portion of a seat corrector according to one embodiment of the invention;

FIG. 12 is a top view of a seat corrector according to one embodiment of the invention;

FIG. 13 is a side view depicting the positioning of a seat corrector according to one embodiment of the invention with respect to a user's pelvic region;

FIG. 14 is a perspective view of a seat corrector according to one embodiment of the invention positioned on an environmental surface that is the seat top of an adjustable chair;

FIG. 15 is a perspective view of a seat corrector according to one embodiment of the invention;

FIG. 16 is a perspective view of a seat corrector according to one embodiment of the invention;

FIG. 17 is a perspective view of a seat corrector according to one embodiment of the invention;

FIG. 18 is a perspective view of a seat corrector according to one embodiment of the invention;

FIG. 19 is a side cross sectional view of an upraised portion of a seat corrector according to one embodiment of the invention;

FIG. 20 is a side cross sectional view of an upraised portion of a seat corrector according to one embodiment of the invention;

FIG. 21 is a side cross sectional view of an upraised portion of a seat corrector according to one embodiment of the invention; and

FIG. 22 is a side cross sectional view of an upraised portion of a seat corrector according to one embodiment of the invention.

### DETAILED DESCRIPTION

Referring to the drawings, similar reference numerals are used to designate the same or corresponding parts throughout the several embodiments and figures. In some drawings, some specific embodiment variations in corresponding parts are denoted with the addition of lower case letters to reference numerals.

According to the invention, a sacroiliac (SI) treatment apparatus and method includes a seat corrector that improves alertness for a user and helps to treat and alleviate SI joint pain, restless legs, poor posture, bladder control problems, leg cramps, ischial tuberosity pain, gluteal bursitis, neck pain, knee pain, hip pain, headaches/migraines, lower back pain, sciatica, peripheral neuropathy, radiculitis, Parkinsons disease, and other conditions benefiting from improved posture and seated pressure on each ischial tuberosity. The invention purposefully cushions and supports rather than off loading the ischial tuberosities. Therefore, among many advantages, several features and objectives include (1) the invention aids in keeping the pelvis and spine in correct anatomical alignment; (2) the invention helps reduce/prevent nerve impingement of the sciatic nerve; and (3) the invention helps prevent ischial tuberosity syndrome (inflammation at the bone prominence).

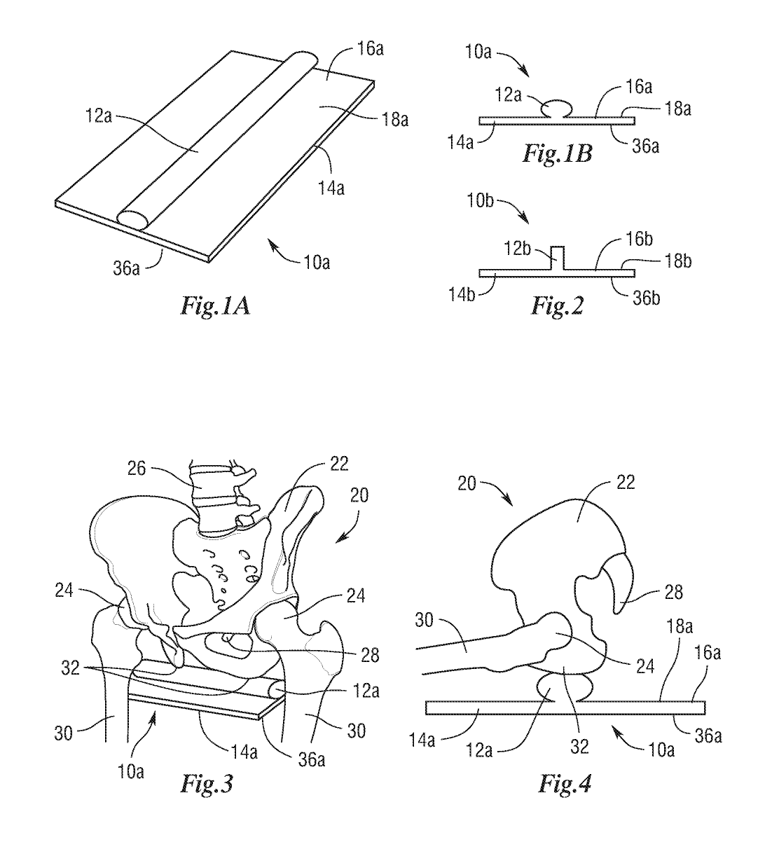

FIG. 1A is a perspective view depicting a sacroiliac treatment apparatus that is a seat corrector 10a of the invention having an upraised portion 12a positioned longitudinally and along the center length 16a of the top surface 18a of a base 14a. The upraised portion 12a is constructed of a firm but flexible material such as rubber/foam rubber, a tightly wound textile, or pliable wood or polymer. The base 14a is often constructed of a more rigid material such as hard wood, less flexible plastic, or metal to provide structural support for the apparatus of the seat corrector 10a. The base 14a is sufficiently firm and structurally strong to maintain flatness and resist the apparatus from assuming a conforming shape to an environmental surface, such as a bench or chair on which the apparatus is placed, when the bottom surface 36a of the apparatus contacts the environmental surface. The base 14a can itself be made out of plastic, wood, metal, high density foam, and/or similar materials, but is nevertheless usually sufficiently lightweight to allow for easy portability. In some contemplated embodiments, both the base 14a and upraised portion 12a can be constructed to be washed or cleaned. In some further contemplated embodiments, a water resistant or water repellant covering (not shown) can be either draped over or conformed over the seat protector 10a. Such protectors may also have a sealable access opening to allow for removal and adjustment of the upraised portion 12a from the base 14a. For comparison, a side view approximating the side and cross sectional profile of the seat corrector apparatus 10a, including the rounded cross sectional profile of the upraised portion 12a, is shown in FIG. 1B.

The upraised portion 12a is usually smaller than the base 14a and, when the bottom surface 36a of the base 14a contacts an environmental surface, the upraised portion 12a is higher than the top surface 18a to create pressure and elevation on the correct part of a user's pelvis. The upraised portion 12a should also be sufficiently firm to support the majority of the user's seated weight when the apparatus is in use and the user properly positioned on the seat corrector 10a. FIGS. 3 and 4 depict an example positioning of the seat corrector 10a with respect to a user's pelvic region 20, pelvic bone 22, hip bones 24, spine 26, and tail bone (coccyx) 28 during use. FIG. 3 depicts the positioning of the seat corrector 10a in a front view of the user's pelvic region 20 and pelvic bone 22. In this front view, it can be seen that when the user sits on and is correctly positioned on the seat corrector 10a, the user's ischial tuberosities 32 exert pressure against the upraised portion 12a of the seat corrector 10a. Comparing FIG. 3 to the side view of FIG. 4, which depicts the relative positioning of the ischial tuberosities 32 and coccyx 28 of the user when seated and correctly positioned on the seat corrector 10a and upraised portion 12a, the majority of the user's seated weight is supported by the upraised portion 12a via the ischial tuberosities 32 and a considerable space separates the coccyx 28 from the base 14a of the seat corrector 10a. As best understood by comparing FIGS. 3 and 4, it is further contemplated that the seat corrector 10a can also be used and can achieve similar advantageous positioning even when the user is laying down.

As best understood by comparing FIGS. 1A and 3, the upraised portion 12a extends the entire length of the base 14a along its top surface 18a. This allows the upraised portion 12a to be sufficiently dimensioned to extend the entire width between the ischial tuberosities 32 of the user and therefore support the majority of the user's seated weight, when the user is seated on the seat corrector 10a, maximizing the pressure directed to the ischial tuberosities 32 and therefore maximizing the therapeutic effects of the directed pressure.

Although shown and described in FIGS. 1A, 1B, 3, and 4 as having a rounded or oval cross section, it will be appreciated that in some contemplated embodiments, the upraised portion can have a squared, rectangular, or other cross sectional shape. For example, FIG. 2 depicts a seat corrector 10b of the invention having an upraised portion 12b with a rectangular cross section that can be constructed of rubber, polymer, stiff foam rubber, or other flexible material. In some contemplated embodiments, the upraised portion 12b can be a highly stiff material such as a 2″×4″ segment of wood or any other material that provides good support against the ischial tuberosity and seated weight of the user.

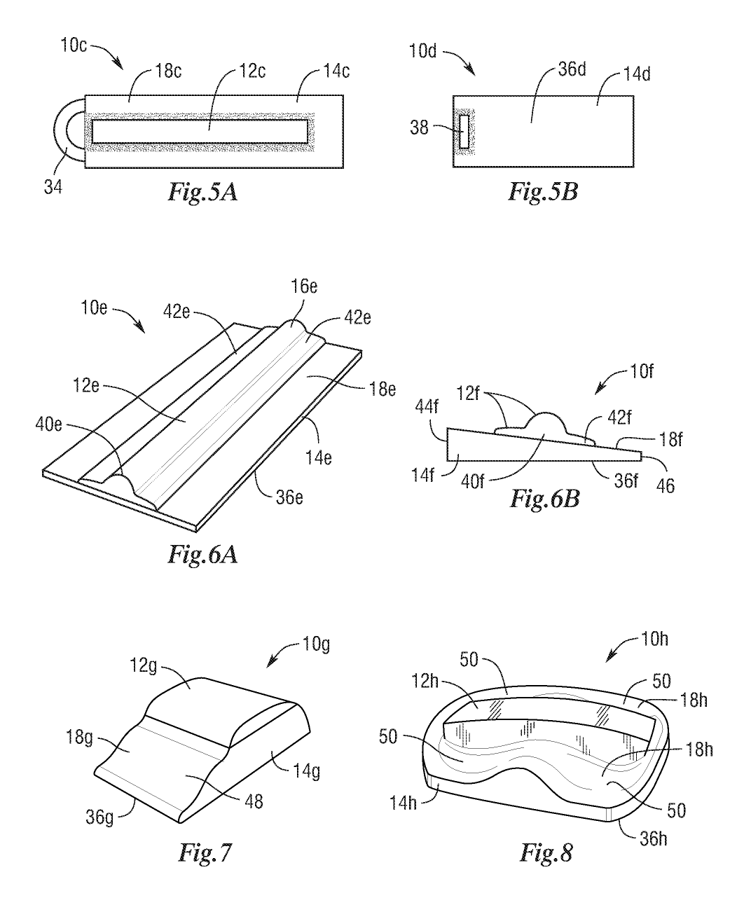

It will be appreciated that the invention can include features that enhance the portability of the seat corrector. For example FIG. 5A depicts a seat corrector 10c of the invention, having a cord 32 attached to one end of the base 14c to allow for easier handling of the seat corrector 10c prior to and following use. FIG. 5B depicts another contemplated embodiment, depicted with the bottom surface 36d visible in FIG. 5B, in which a handle 38 is incorporated into the structure and located at one end of the base 14d. It will be appreciated that other enhancements can also be incorporated into the seat corrector 10c within the anticipated scope of the invention.

It will be further appreciated that other modifications to the base and upraised portion of the seat corrector are also possible. For example, FIG. 6A is a perspective view of a seat corrector 10e having an upraised portion 12e that includes an upper protrusion 40e extending along the middle length of the upraised portion 12e and further above the top surface 18e base 14e of the seat corrector 10e. The tops of two lower edges 42e are closer to the top surface 18e of the base 14e along the length of the upraised portion 12e.

FIG. 6B depicts a side view of a seat corrector 10f of the invention that is similar to the seat corrector 10e of FIG. 6A and with a similar upraised portion 12f except in FIG. 6B, the depicted seat corrector 10f includes a base 14f with a tapered top surface 18f in which the thickness of the base 14f is greater near the back 44 (usually positioned away from the user's legs) of the seat corrector 10f than at the front 46 (usually positioned closer to or adjacent the user's legs).

Other variations to the upraised portion and base are also possible within the anticipated scope of the invention. For example, FIG. 7 is a perspective view of a seat corrector 10g of the invention having an upraised portion 12g that features a broad and flattened shape to extend partially along the top surface 18g of the base 14g. The base 14g further includes a tapered portion 48 of the top surface 18g. It is contemplated that in many similarly constructed embodiments of the invention, the tapered portion 48 is usually positioned toward the user's legs while the upraised portion 12g is positioned away from the user's legs.

It is further contemplated that in some anticipated embodiments, the seat corrector can include features that facilitate the correct positioning of the ischial tuberosity against the upraised portion during use.

For example, FIG. 8 depicts a perspective view of a seat corrector 10h of the invention in which the upraised portion 12h is positioned on a base 14h that is formed into a bucket seat. The base 14h incudes bucket indentations 50 shaped to roughly conform to and engage the seated profile of the user's buttocks and legs to enable proper positioning of the upraised portion 12h against the user's ischial tuberosity and away from the user's coccyx and lower back.

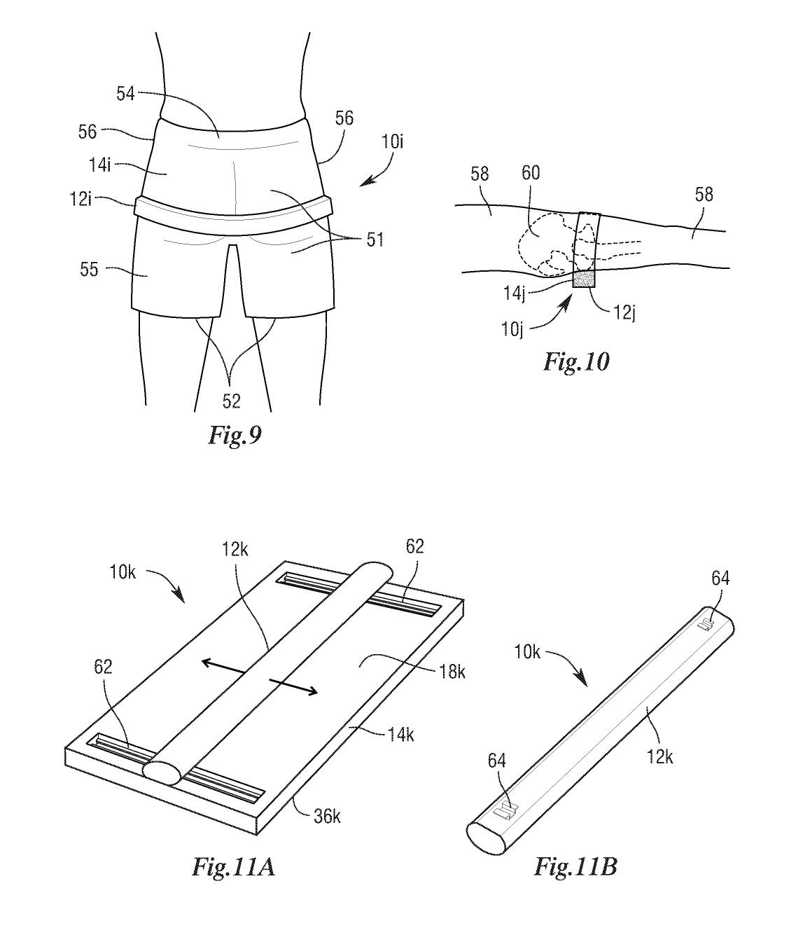

FIG. 9 depicts a back view of another contemplated seat corrector 10i of the invention in which the seat corrector 10i is formed into a pair of wearable short pants or undergarments 55. The upraised portion 12i is positioned in the seat 51 of the base 14i. When the corrector is worn by a user, the legs 51 and belt or elastic band 54 and pant hips 56 provide correct upraised portion 12i positioning against the ischial tuberosities by engagement with respect to the user's waist, buttocks, and legs. It is contemplated that the user would sit on a separate rigid base (not shown in FIG. 9) while wearing the pants or undergarments 55 and directing pressure of the upraised portion 12i against the user's ischial tuberositites.

FIG. 10 depicts a side view of another contemplated apparatus 10j of the invention having a securement strap 60 to secure and improve positioning of the upraised portion 12j against the ischial tuberosities of the user 58, who is depicted in FIG. 10 in a lying, down position. As shown in FIG. 10, the securement strap 60 secures the base 14j against the buttocks or pelvic area of the user 58 for proper upraised portion 12j positioning. The securement strap 60 can be constructed of cloth, rope, VELCRO™ material or other like strap material and the ends of the resulting wrap attached and connected with a buckle, VELCRO™ material, snap, tie, or other securement means. It is further contemplated that the securement strap can, in some embodiments, be structurally incorporated into the base or comprise and function as the base itself. It is also contemplated that the user could lay on a separate rigid base (not shown in FIG. 10) while wearing the apparatus 10j and directing pressure of the upraised portion 12j against the user's ischial tuberositites.

It will be further appreciated that in some contemplated embodiments, the positioning of the upraised portion can be adjusted with respect to the base to allow for size or treatment adjustments or to account for physical variations or sizing among users. For example, referring now to both FIGS. 11A and 11B, FIG. 11A depicts a perspective view of the base 14k of a seat corrector 10k of the invention in which the corresponding upraised portion 12k is movable and depicted in the bottom view of FIG. 11B. As best understood by comparing FIGS. 11A and B, the base 14k shown in FIG. 11A includes two adjustable track female portions 62 on the top surface 18k, each track female portion 62 being located near an end of the base 14k. Corresponding male portions 64k are positioned on the bottom and near each end of the upraised portion 12k to allow for slidable engagement along the track female portions 62 of the base 14k. This allows for variable and selected positioning of the upraised portion 12k when mounted on the base 14k. In some contemplated embodiments, pins, screws, or other locking mechanisms may be added to secure the relative positioning of the upraised portion once the desired positioning has been selected. In still further contemplated embodiments, other variable and selectable mounting apparatuses such as VELCRO™ strips, clamps, mounting hardware, spring and pegs, base coverings, or other releasable means can be utilized.

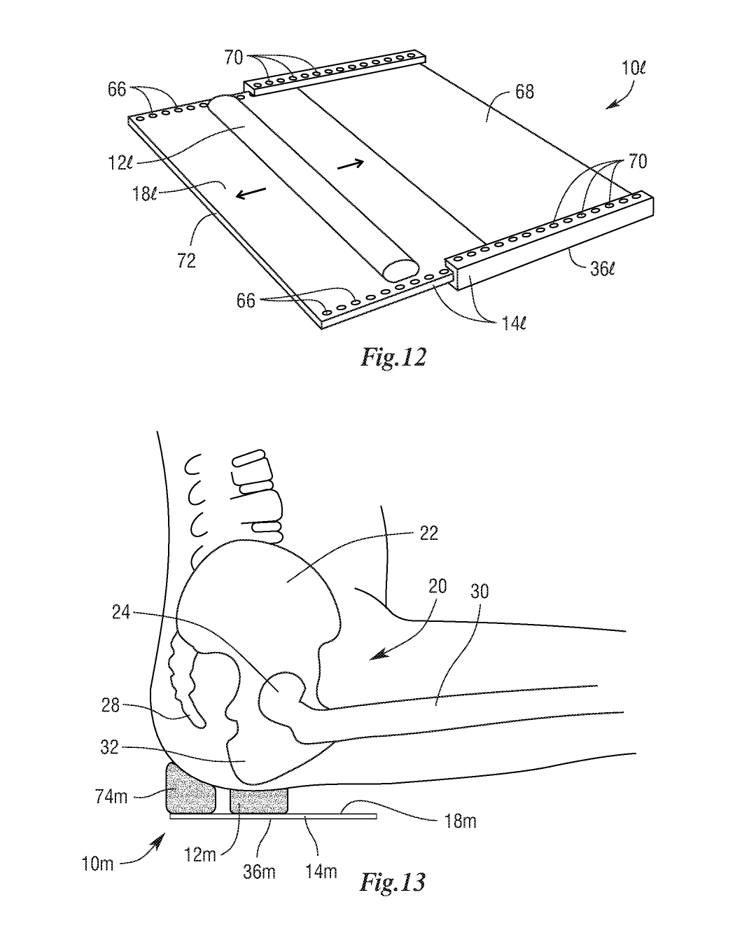

For example, FIG. 12 depicts a seat corrector 10l of the invention in which the upraised portion 12l is fixedly positioned on a two-part base 14l including a box base component 68 and a slidable base component 72. Several securement holes 66 are positioned along each end of the slidable base component 72. The slidable base component 72 provides variable positioning of the upraised portion 12l with respect to the box base component 68. The box base component 68 also includes at each end several insertion holes 70 that can be aligned with one or more of the securement holes 66 of the slidable base component 72 to allow locked positioning of the slidable base component 72 with respect to the box base component 68 with one or more pins (not shown in FIG. 12) simultaneously inserted through both securement holes 66 and insertion holes 70. The box base component 68 also provides the bottom surface 36l of the base and seat corrector 10l to contact and resist conforming shape to an environmental surface (not shown in FIG. 12).

Although the invention has been shown and described with the majority of the user's seated weight being supported by the upraised portions of the described seat correctors while the upraised portions exert pressure against the user's ischial tuberosities, it will be appreciated that additional weight support components can also be included within the intended scope of the invention. For example, FIG. 13 depicts a curved seat corrector 10m of the invention properly positioned with respect to a seated user's pelvic region 20, pelvic bone 22, hip bones 24, and tail bone (coccyx) 28 during use. In addition to the upraised portion 12m, the seat corrector 10m also includes a gluteus maximus support 74m positioned on the top surface 18m of the base 14m. In this contemplated embodiment of the invention, the gluteus maximus support 74m both serves to bear some of the user's seated weight and further serves to assist in body stabilization in the seated position and proper positioning with respect to the seat corrector 10m and upraised portion 12m while leaving an existing space between the gluteus maximus support 74m and tail bone 28. In some embodiments, the gluteus maximus support 74m may be both removable from the base 14m and washable.

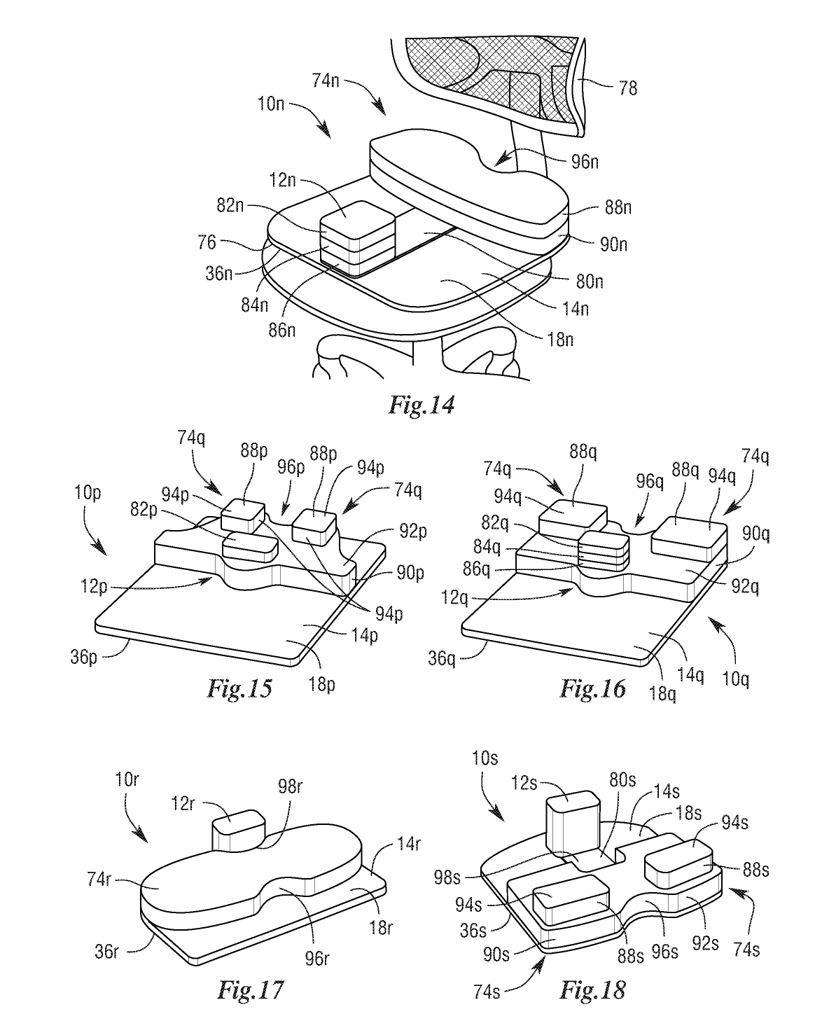

It will be further appreciated that both the upraised portion and gluteus maximus support of an apparatus of the invention can include multiple layers, each with similar or differing magnitudes of firmness. For example, FIG. 14 depicts, in a perspective view, a seat corrector 10n of the invention positioned on an environmental surface that is the seat top 76 of an adjustable chair 78. The bottom surface 36n of the base 14n rests on and resists conforming its shape to the seat top 76 due to the high level of stiffness of the base 14n itself. The gluteus maximus support 74n is positioned along and affixed to the top surface 18n of the base 14n and one end of an adjustable cloth or slider 80 fixed to either the gluteus maximus support 74n, the base 14n, or therebetween. The upraised portion 82n is positioned on the other end of the adjustable cloth or slider 80 and can therefore be variably located by the user at a selected location on the top surface 18n of the base 14n for optimal positioning to correctly direct pressure to the user's ischial tuberosities.

The upraised portion 12n includes a top upraised layer 82n, a center upraised layer 84n, and a bottom upraised layer 86n all in parallel planes. Depending on the embodiment, all of the upraised layers 82n, 84n, and 86n may share a similar magnitude of firmness or, alternatively, one or all of the three upraised layers 82n, 84n, and 86n may possess a level of firmness different than the other two. Similarly, the gluteus maximus support includes both a top support layer 88n and a bottom support layer 90n, with both of the support layers 88n and 90n, depending on the embodiment, either sharing a similar magnitude of firmness or possessing a level of firmness that is different from the other. The variations in layer stiffness can be selected prior to construction depending on the desired therapeutic effect of the apparatus.

It will be further appreciated that in some embodiments, it may be useful or desirable that both the gluteus maximus support and upraised portion share one or more layers, and/or that the gluteus maximus supports be divided into separate segments, and that such embodiments are within the intended scope of the invention. For example, FIG. 15 depicts a seat corrector 10p of the invention in which both the top upraised layer 82p of the upraised portion 12p and the top support layers 88p of two separate gluteus maximus support segments 94p are both positioned on a shared bottom layer 92p positioned on the top surface 18p of the base 14p. A coccyx cut out 96p is added to the shared bottom layer 92p, and along with the space between the gluteus maximus support segments 94p, helps reduce additional stress that might otherwise be exerted on the coccyx. Some embodiments may allow for differences in the relative firmness between the top upraised layers/top support layers 82p and 88p and the shared bottom layer 92p, while other embodiments may have no variation in the relative firmness of coplanar layers, depending on the intended and desired therapeutic effect of the seat corrector 10p.

The invention further contemplates variations in the number of coplanar layers positioned on a shared bottom layer or other layer. For example, FIG. 16 depicts a further contemplated embodiment seat corrector 10q in which a top upraised layer 82q, a center upraised layer 84q, and a bottom upraised layer 86q of the upraised portions, all in parallel planes, as well as a gluteus maximus support 74q divided into two gluteus maximus support segments 94q, are all positioned on a shared bottom layer 92q. In this embodiment, the gluteus maximus support segments 94q are customized and slightly larger. The relative magnitudes of firmness among the upraised portion segments 82q, 84q, and 86q, the gluteus maximus support segments 94q, and the shared bottom layer 92q can be selected to be similar onto vary depending on the desired therapeutic effect of the seat corrector 10q.

It will be further appreciated that the upraised portion can be positioned at locations that are near but not necessarily on the top surface of the base. Referring now to FIG. 17, a seat corrector 10r of the invention includes an upraised portion 12r positioned just in front of the gluteus maximus support 74r and base 14r rather than being positioned along the top surface 18r of the base 14r itself. The gluteus maximus support 74r also includes a coccyx cut out 96r to allow the user to be seated with pressure directed by the upraised portion 12r to the ischial tuberosities and support given to the gluteus maximus by the gluteus maximus support 74r, but without pressure being exerted directly on the coccyx itself. Although described in this manner, it will also be appreciated that in some contemplated embodiments, the base 14r could be extended beyond the front of the gluteus maximus support 74r or at least sufficiently far forward to allow the top surface 18r of the base 14r to extend into the area of the upraised portion accommodation notch 98r. Such an alternate embodiment would allow the upraised portion 12r to extend along and be supported by the top surface 18r of the base 14r for added stability.

FIG. 18 depicts a perspective view of the seat corrector 10s in which the gluteus maximus support 74s is positioned along and affixed to the top surface 18s of the base 14s and one end of an adjustable cloth or slider 80s fixed to either the gluteus maximus support 74s, the base 14s, or therebetween. The upraised portion 12s is positioned on the other end of the adjustable cloth or slider 80s and can therefore be variably located by the user at a selected location on the top surface 18s of the base 14s. This allows for optimal positioning to correctly direct pressure to the user's ischial tuberosities. The upraised portion 12s can also be positioned to fit within the upraised portion accommodation notch 98s for added lateral stability. The top support layers 88s of two separate gluteus maximus support segments 94s are both positioned on a shared bottom layer 92s positioned on the top surface 18s of the base 14s. A coccyx cut out 96s is added to the shared bottom layer 92s, and along with the space between the gluteus maximus support segments 94s, helps reduce additional stress that might otherwise be exerted on the coccyx. Relative magnitudes of firmness of the top support layers 88s and the shared bottom layer 92s of the gluteus maximus support 74s can be selected depending on the intended and desired therapeutic effect of the seat corrector 10s.

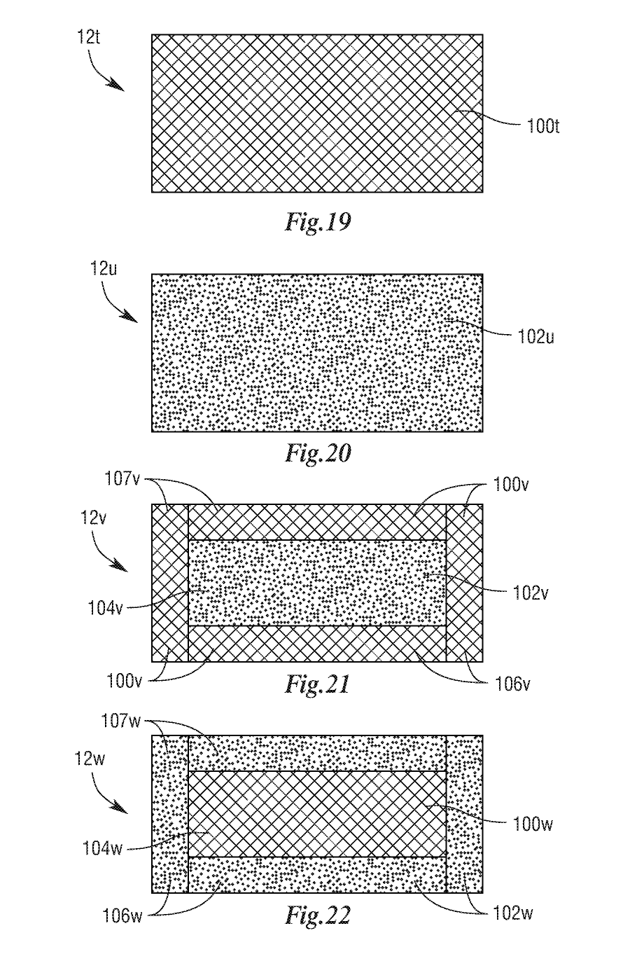

Although the invention has been shown and described with multilayered upraised portions in which parallel, planar layers possess differing magnitudes of firmness, it, will be appreciated that other configurations with varying magnitudes of firmness are also possible. For example, consider the side cross sectional view of an upraised portion 12t in FIG. 19 which is entirely constructed of a firmer material 100t wherein the entire upraised portion possesses a single magnitude of greater firmness. Now compare FIG. 19 with the side cross sectional view of an upraised portion 12u in FIG. 20 which is entirely constructed of a softer material 102u wherein the entire upraised portion 12u possesses a single magnitude of firmness that is less than the single magnitude of firmness of the upraised portion 12t of FIG. 19.

Referring now to FIG. 21, an upraised portion 12v can also be constructed with an inner support layer 104v comprising softer materials 102v. A surrounding support layer 106v can then comprise surrounding material segments 107v of firmer material 100v to achieve a desired therapeutic pressure effect by the upraised portion that is different than the upraised portions 12t and 12u in FIGS. 19 and 20.

Now compare FIG. 21 with the upraised portion 12w of FIG. 22, in which an inner support layer 104w comprises firmer materials 100w and in which a surrounding support layer 106w can then comprise surrounding material segments 107w of softer material 102w to achieve a different therapeutic effect than the upraised portions 12t, 12u, and 12v of FIGS. 19, 20, and 21.

Although variations in softer and firmer layers of upraised portions have been shown and described in FIGS. 19 through 22, it will be appreciated that equivalent variations can also be achieved in gluteus maximus supports of the invention as well.

Those skilled in the art will realize that this invention is capable of embodiments different from those shown and described. It will be appreciated that the detail of the structure of the disclosed apparatuses and methodologies can be changed in various ways without departing from the invention itself. Accordingly, the drawings and Detailed Description are to be regarded as including such equivalents as do not depart from the spirit and scope of the invention.

1. A sacroiliac treatment apparatus comprising:
a base, said base having a top surface and a bottom surface, said base being sufficiently firm to resist said apparatus assuming a conforming shape to an environmental surface upon which said sacroiliac treatment apparatus is placed when said bottom surface of said sacroiliac treatment apparatus contacts the environmental surface;
an upraised portion, said upraised portion having an upper surface, said upraised portion positioned along or near said top surface of said base, said upper surface of said upraised portion being higher than said top surface of said base when said bottom surface of said sacroiliac treatment apparatus contacts the environmental surface;
said upraised portion positioned to exert pressure against both ischial tuberosities of the user and support the majority of the user's seated weight when the user is seated on said sacroiliac treatment apparatus; and
said upper surface of said upraised portion extending at least the entire width between the ischial tuberosities of the user when the user is seated on said sacroiliac treatment apparatus.

2. The sacroiliac treatment apparatus of claim 1 further comprising a gluteus maximus support positioned on or near the top surface of said base, said gluteus maximus support being positioned to support the gluteus maximus of the user when the user is seated on said sacroiliac treatment apparatus.

3. The sacroiliac treatment apparatus of claim 2 wherein said gluteus maximus support includes a plurality of support layers, at least one said support layer having a different magnitude of firmness than at least one other said support layer.

4. The sacroiliac treatment apparatus of claim 2 wherein said gluteus maximus support includes a plurality of support layers, all of said support layers having a similar magnitude of firmness.

5. The sacroiliac treatment apparatus of claim 2 wherein said gluteus maximus support is divided into two gluteus maximus support segments.

6. The sacroiliac treatment apparatus of claim 1 wherein said upraised portion includes a plurality of support layers, at least one said support layer having a different magnitude of firmness than at least one other said support layer.

7. The sacroiliac treatment apparatus of claim 1 wherein said upraised portion includes a plurality of support layers, all of said support layers having a similar magnitude of firmness.

8. The sacroiliac treatment apparatus of claim 1 wherein said upraised portion has an oval cross sectional shape.

9. The sacroiliac treatment apparatus of claim 1 wherein said upraised portion has a rectangular cross sectional shape.

10. The sacroiliac treatment apparatus of claim 1 wherein said upraised portion has a circular cross sectional shape.

11. The sacroiliac treatment apparatus of claim 1 wherein said upraised portion includes at least one inner support layer and at least one surrounding support layer, at least one said inner support layer having a different magnitude of firmness than at least one surrounding said support layer.

12. The sacroiliac treatment apparatus of claim 1 wherein said upraised portion includes at least one inner support layer and at least one surrounding support layer, all of said support layers having a similar magnitude of firmness.

13. The sacroiliac treatment apparatus of claim 1 wherein said apparatus is positionable with a handle.

14. The sacroiliac treatment apparatus of claim 1 wherein said top surface of said base is tapered.

15. The sacroiliac treatment apparatus of claim 1 wherein said top surface of said base includes a tapered portion.

16. The sacroiliac treatment apparatus of claim 1 wherein said upraised portion includes an upper protrusion.

17. The sacroiliac treatment apparatus of claim 1 wherein said apparatus is formed into a bucket seat.

18. The sacroiliac treatment apparatus of claim 1 wherein said apparatus is formed into a pair of wearable pants.

19. The sacroiliac treatment apparatus of claim 1 wherein said apparatus is secured to a wearer with a securement strap.

20. The sacroiliac treatment apparatus of claim 1 wherein the positioning of said upraised portion can be adjusted with respect to said base.

21. The sacroiliac treatment apparatus of claim 1 further comprising a protective covering draped or conformed over said base and said upraised portion.

22. The sacroiliac treatment apparatus of claim 1 further comprising a protective covering draped or conformed over said base and said upraised portion, said protective covering being water resistant or water repellant.

23. A sacroiliac treatment apparatus comprising:
a base, said base having a top surface and a bottom surface, said base being sufficiently firm to resist said apparatus assuming a conforming shape to an environmental surface upon which said sacroiliac treatment apparatus is placed when said bottom surface of said sacroiliac treatment apparatus contacts the environmental surface;
an upraised portion, said upraised portion having an upper surface, said upraised portion positioned along or near said top surface of said base, said upper surface of said upraised portion being higher than said top surface of said base when said bottom surface of said sacroiliac treatment apparatus contacts the environmental surface;
said upraised portion positioned to exert pressure against both ischial tuberosities of the user and support the majority of the user's seated weight when the user is seated on said sacroiliac treatment apparatus;
said upper surface of said upraised portion extending at least the entire width between the ischial tuberosities of the user when the user is seated on said sacroiliac treatment apparatus;
a gluteus maximus support positioned on the top surface of said base, said gluteus maximus support being positioned to support the gluteus maximus of the user when the user is seated on said sacroiliac treatment apparatus; and
said gluteus maximus support having a cut out to prevent the exertion of pressure against the coccyx of the user when the user is seated on said sacroiliac treatment apparatus.

24. The sacroiliac treatment apparatus of claim 23 wherein said upraised portion includes a plurality of support layers, at least one said support layer having a different magnitude of firmness than at least one other said support layer.

25. The sacroiliac treatment apparatus of claim 23 wherein said upraised portion includes a plurality of support layers, all of said support layers having a similar magnitude of firmness.

26. The sacroiliac treatment apparatus of claim 23 wherein said gluteus maximus support includes a plurality of support layers, at least one said support layer having a different magnitude of firmness than at least one other said support layer.

27. The sacroiliac treatment apparatus of claim 23 wherein said gluteus maximus includes a plurality of support layers, all of said support layers having a similar magnitude of firmness.

28. The sacroiliac treatment apparatus of claim 23 wherein said upraised portion has an oval cross sectional shape.

29. The sacroiliac treatment apparatus of claim 23 wherein said upraised portion has a rectangular cross sectional shape.

30. The sacroiliac treatment apparatus of claim 23 wherein said upraised portion has a circular cross sectional shape.

31. The sacroiliac treatment apparatus of claim 23 wherein said upraised portion includes at least one inner support layer and at least one surrounding support layer, at least one said inner support layer having a different magnitude of firmness than at least one surrounding said support layer.

32. The sacroiliac treatment apparatus of claim 23 wherein said upraised portion includes at least one inner support layer and at least one surrounding support layer, all of said support layers having a similar magnitude of firmness.

33. The sacroiliac treatment apparatus of claim 23 wherein said apparatus is positionable with a handle.

34. The sacroiliac treatment apparatus of claim 23 wherein said top surface of said base is tapered.

35. The sacroiliac treatment apparatus of claim 23 wherein said top surface of said base includes a tapered portion.

36. The sacroiliac treatment apparatus of claim 23 wherein said upraised portion includes an upper protrusion.

37. The sacroiliac treatment apparatus of claim 23 wherein said apparatus is foamed into a bucket seat.

38. The sacroiliac treatment apparatus of claim 23 wherein said apparatus is formed into a pair of wearable pants.

39. The sacroiliac treatment apparatus of claim 23 wherein said apparatus is secured to a wearer with a securement strap.

40. The sacroiliac treatment apparatus of claim 23 wherein the positioning of said upraised portion can be adjusted with respect to said base.

41. The sacroiliac treatment apparatus of claim 23 wherein said gluteus maximus support is divided into two gluteus maximus support segments.

42. The sacroiliac treatment apparatus of claim 23 further comprising a protective covering draped or conformed over said base, said upraised portion, and said gluteus maximus support.

43. The sacroiliac treatment apparatus of claim 23 further comprising a protective covering draped or conformed over said base, said upraised portion, and said gluteus maximus support, said protective covering being water resistant or water repellant.

44. A method for providing sacroiliac treatment comprising:
providing a sacroiliac treatment apparatus having a base, said base having a top surface and a bottom surface, said base being sufficiently firm to resist said apparatus assuming a conforming shape to an environmental surface upon which said sacroiliac treatment apparatus is placed when said bottom surface of said sacroiliac treatment apparatus contacts the environmental surface;
providing an upraised portion, said upraised portion having an upper surface, said upraised portion positioned along or near said top surface of said base, said upper surface of said upraised portion being higher than said top surface of said base when said bottom surface of said sacroiliac treatment apparatus contacts the environmental surface, said upper surface of said upraised portion extending at least the entire width between the ischial tuberosities of a user when the user is seated on said sacroiliac treatment apparatus;
seating the user on said sacroiliac treatment apparatus and exerting pressure with said upraised portion against both ischial tuberosities of the user, supporting the majority of the user's seated weight with said upraised portion.

45. The method of claim 44 further comprising providing a gluteus maximus support positioned on or near the top surface of said base and supporting the gluteus maximus of the user with said gluteus maximus support when the user is seated on said sacroiliac treatment apparatus.

46. The method of claim 44 further comprising:
providing a gluteus maximus support positioned on or near the top surface of said base and supporting the gluteus maximus of the user with said gluteus maximus support when the user is seated on said sacroiliac treatment apparatus; and
providing a cut out on said gluteus maximus support to prevent the exertion of pressure against the coccyx of the user when the user is seated on said sacroiliac treatment apparatus.
